(19) United States
(12) Patent Application Publication
(10) Pub. No.: US 2015/0166373 A1
(43) Pub. Date: Jun. 18, 2015

(54) SYSTEM AND METHOD FOR CAPACITIVE DEIONIZATION

(71) Applicant: University of Kentucky Research Foundation, Lexington, KY (US)

(72) Inventors: James Landon, Lexington, KY (US); Aaron Cramer, Lexington, KY (US); Kunlei Liu, Lexington, KY (US); Zhiao Li, Lexington, KY (US)

(73) Assignee: University of Kentucky Research Foundation, Lexington, KY (US)

(21) Appl. No.: 14/266,963

(22) Filed: May 1, 2014

Related U.S. Application Data
(63) Continuation-in-part of application No. 14/230,668, filed on Mar. 31, 2014.
(60) Provisional application No. 61/915,794, filed on Dec. 13, 2013.

(51) Int. Cl. C02F 1/469

(52) U.S. Cl. CPC C02F 1/4691

(57) ABSTRACT

A capacitive deionization system includes a first deionization cell, a second deionization cell and an integrated DC/DC converter/power source. The first deionization cell includes a first reservoir and a first set of electrode pairs. The second deionization cell includes a second reservoir and a second set of electrode pairs.

This utility patent application is a continuation-in-part of U.S. patent application Ser. No. 14/230,668 filed on Mar. 31, 2014, which claims the benefit of priority in U.S. Provisional Patent Application Ser. No. 61/915,794 filed on Dec. 13, 2013, the entirety of the disclosure of which is incorporated herein by reference.

### TECHNICAL FIELD

This document relates to desalination technology and, more particularly, to an electrochemical method and system for capacitive deionization of salt water.

### BACKGROUND

Capacitive deionization (CDI) is a maturing technology for the desalination of water. In general, a voltage is applied across a CDI cell. Ions are adsorbed on the polarized electrodes and this leads to a deionized solution. The electrodes may then be regenerated by shorting or reversing the polarity. This serves to concentrate the ions back into the solution stream.

This document relates generally to a new and improved system and method for capacitive deionization. Advantageously, the system and method allow for more efficient and effective desalination of water.

### SUMMARY

In accordance with the purposes and benefits described herein, a capacitive deionization system is provided. That system comprises a first deionization cell including a first chamber or reservoir and a first set of electrode pairs and a second deionization cell including a second chamber or reservoir and a second set of electrode pairs. Further the system includes an integrated DC/DC converter/power source connected to the first and second sets of electrode pairs. In one embodiment of the system, the first and second deionization cells are provided in geometric parallel so that one deionization cell may be charged while the other deionization cell is being discharged. In one possible embodiment the converter includes an integrated power source.

In accordance with additional aspects, the system also includes a conductivity sensor for monitoring conductivity of desalinated water being discharged from either the first or second deionization cells. In one possible embodiment the system also includes a pH sensor for monitoring pH of desalinated water being discharged from either of the first and second deionization cells. In addition, a pump is provided for pumping salt water through the cells.

Still further a controller is connected to the DC/DC converter, the conductivity sensor, the pH sensor and the pump. In addition a first flow control valve is provided between the pump and the first and second deionization cells. This valve selectively directs salt water from the pump to the first or second deionization cell. Further the system includes a wastewater reservoir and a desalinated water reservoir. A second flow control valve downstream from a first outlet of the first deionization cell selectively directs flow to the wastewater or desalinated water reservoir. A third flow control valve downstream from a second outlet of the second deionization cell selectively directs flow to the wastewater or desalinated water reservoir.

In one possible embodiment the electrode pairs are xerogel electrodes with a silica film coating.

In accordance with yet another aspect, a method of capacitive deionization is provided in a capacitive deionization system including a first deionization cell having a first set of electrode pairs, a second deionization cell having a second set of electrode pairs, an integrated DC/DC converter/power source and a controller. That method may be described as comprising the steps of: (a) pumping salt water, by a pump, into the first deionization cell at a predetermined processing rate, (b) applying, by operation of the converter, a processing voltage across the first set of electrode pairs to deionize the salt water and produce desalinated water, (c) directing, by flow control valve, the desalinated water from the first deionization cell to a desalinated water reservoir and (d) applying, by operation of the converter, the processing voltage for the first set of electrode pairs by discharging the second deionization cell and adding topping power from the integrated power source.

In addition the method includes the step of (e) monitoring, by conductivity sensor, conductivity of the desalinated water discharged from the first deionization cell and stopping, by operation of the controller, application of processing voltage to the first set of electrode pairs upon the conductivity reaching a predetermined level. Further the method includes the step of (f) directing, by flow control valve, a wastewater stream from the second deionization cell to a wastewater reservoir.

In addition the method includes the steps of: (g) pumping, by a pump, salt water into the second deionization cell at a predetermined processing rate, (h) applying, by operation of the converter, a processing voltage across the second set of electrode pairs to deionize the salt water and produce desalinated water, (i) directing, by flow control valve, the desalinated water from the second deionization cell to the desalinated water reservoir and (j) applying, by operation of the converter, the processing voltage for the second set of electrode pairs by discharging the first deionization cell and adding topping power from the integrated power source.

Still further the method includes the step of (k) monitoring, by conductivity sensor, conductivity of the desalinated water exiting the second deionization cell and stopping, by operation of the converter, application of processing voltage to the second set of electrode pairs upon the conductivity reaching a predetermined level. In addition the method includes (l) directing, by flow control valve, a wastewater stream from the first deionization cell to the wastewater reservoir. In addition the method includes the steps of repeating steps (a)-(l) indefinitely.

In the following description, there is shown and described several preferred embodiments of the system and method for capacitive deionization. As should be appreciated, the system and method are capable of other, different embodiments and their several details are capable of modification in various, obvious aspects all without departing from the subject matter as set forth in the claims presented in this document. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the present system and method and together with the description serve to explain certain principles thereof. In the drawings:

FIG. 1 is a schematical block diagram illustrating the fluid circuit of the present capacitive deionization system.

FIG. 2 is a schematical block diagram illustrating the control architecture for the capacitive deionization system.

FIG. 3 is a schematical side elevational view illustrating the general construction of a deionization cell.

FIG. 4 is a schematical block diagram of the controller.

FIG. 5 is a graph illustrating the salt capacity the carbon electrodes in a CDI cell as a function of cycle number, each cycle consisting of a charging and discharging process. REV. means that the electrodes were reversed (positive and negative connections switched). System performance is maintained by increases in the voltage as well as electro-potential reversal.

FIG. 6 is a schematical illustration of the integrated DC/DC converter/power source used in the system.

Reference will now be made in detail to the present preferred embodiment of the system and method, examples of which are illustrated in the accompanying drawings.

### DETAILED DESCRIPTION

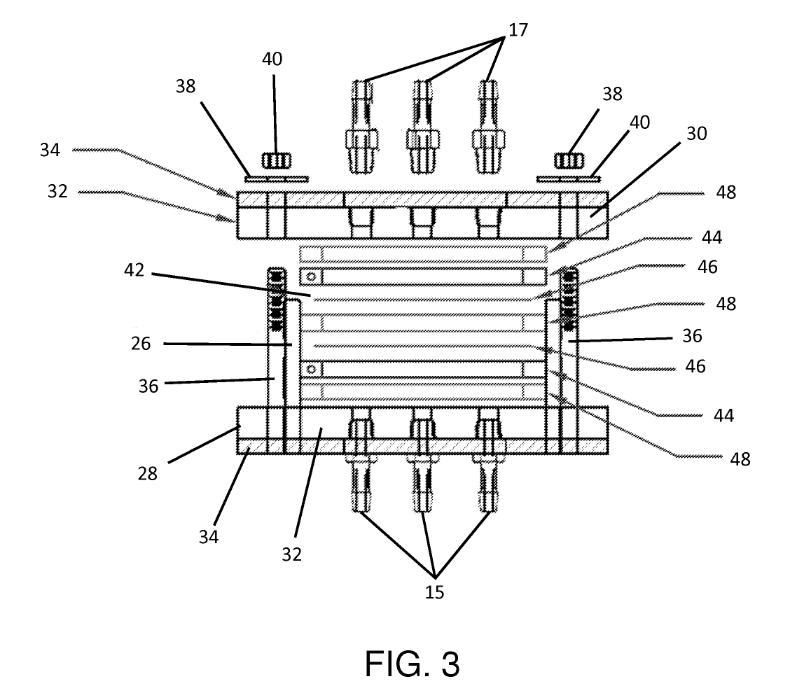

Reference is now made to FIG. 3 generally illustrating the construction of an individual deionization cell 11. As illustrated, the cell 11 includes a vessel or housing 24 comprising a sidewall 26 sandwiched between two endplates 28, 30. Each endplate 28, 30 may comprise a noryl plate 32 backed by an aluminum bolster 34. A plurality of clamping studs 36 and cooperating nuts 38 and washers 40 secure the sidewall 26 and endplates 28, 30 together to form the interior reservoir 42. Each reservoir 42 holds a stack of titanium current collectors 44, monolithic and flexible carbon electrodes 46 and polytetrafluorethylene spacers 48. Each cell 11 is modular meaning the number of current collectors 44, electrodes 46 and spacers 48 may be added in series to increase the deionization capability of each cell and the overall system 10. Finally, each cell 11 includes an inlet 15 (note three polyvinylidene fluoride (PVDF) connections) and an outlet 17 (see three PVDF connections).

The electrodes 46 are typically made from porous carbon materials such as activated carbon, carbon black, carbon nanotubes, carbon xerogel, carbon aerogel or the like. A particularly useful highly conductive and porous electrode for the adsorption of ions from the salt water may be made from carbon xerogel coated with a silica film. Such an electrode is disclosed in parent U.S. patent application Serial No. 14,230,668, the full disclosure of which is incorporated herein by reference.

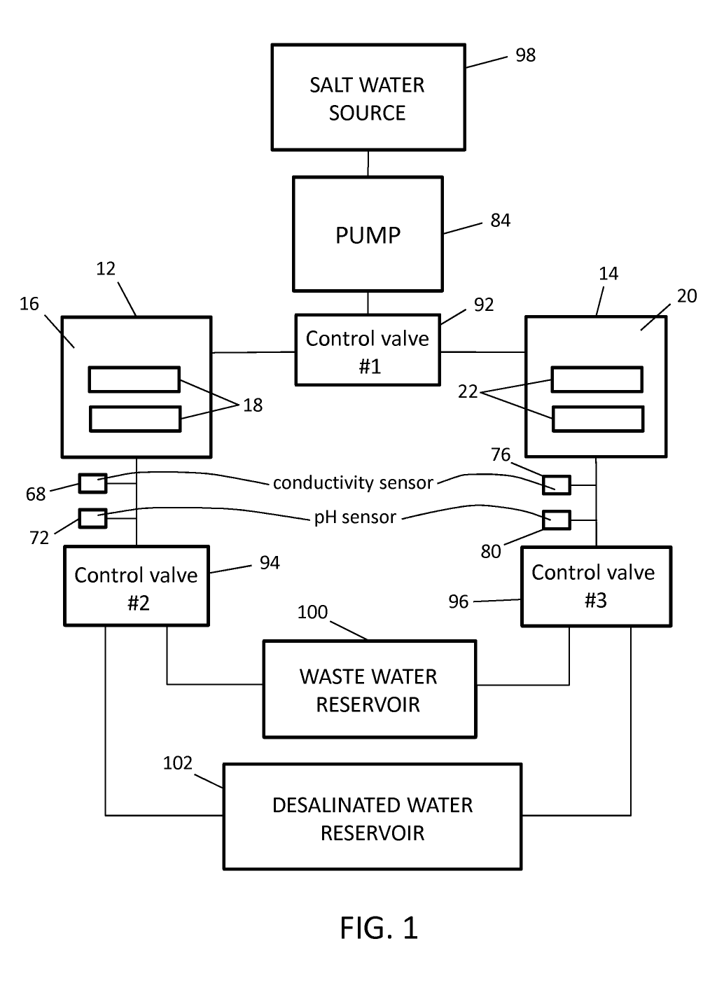

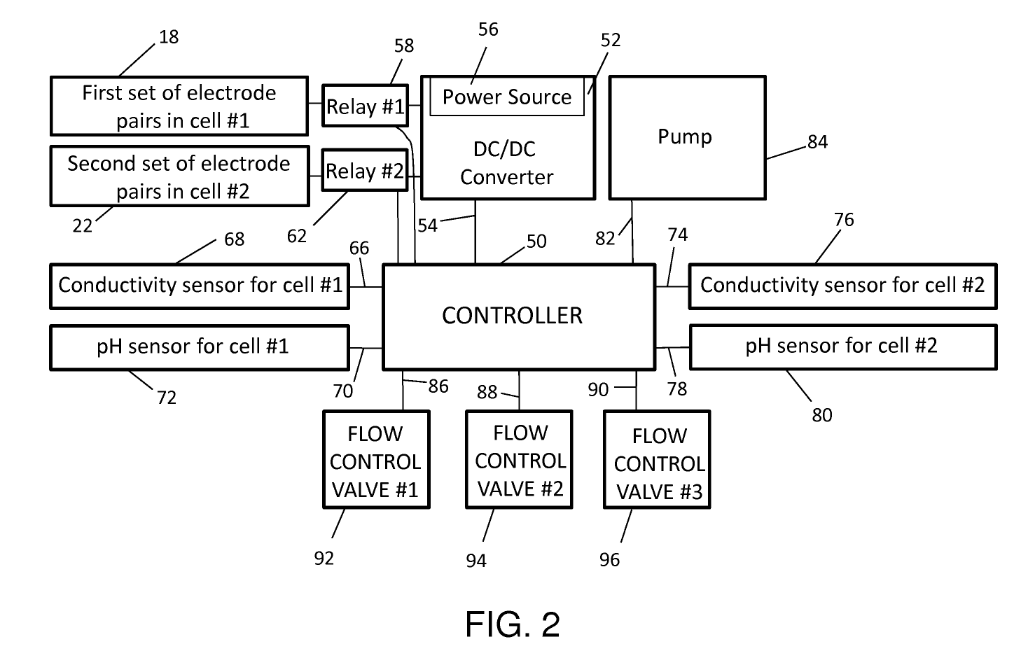

Reference is now made to FIGS. 1 and 2 illustrating the capacitive deionization system 10. That system 10 includes a first deionization cell 12 and a second deionization cell 14 similar to the electrodes 46 described above. The first deionization cell 12 includes a first reservoir 16 and a first set of electrode pairs 18. The second deionization cell 14 includes a second reservoir 20 and a second set of electrode pairs 22 also similar to the electrodes 46 described above.

It should be appreciated that the first deionization cell 12 may comprise a single cell, such as illustrated at 11 in FIG. 3; or a first bank of a plurality of such cells. Similarly, the second deionization cell 14 may comprise a single cell 11 or a second bank of a plurality of such cells. In any embodiment, the first and second deionization cells 12, 14 are provided in geometric (not electric) parallel so that one cell may be charged while the other cell is being discharged in a manner described in greater detail below.

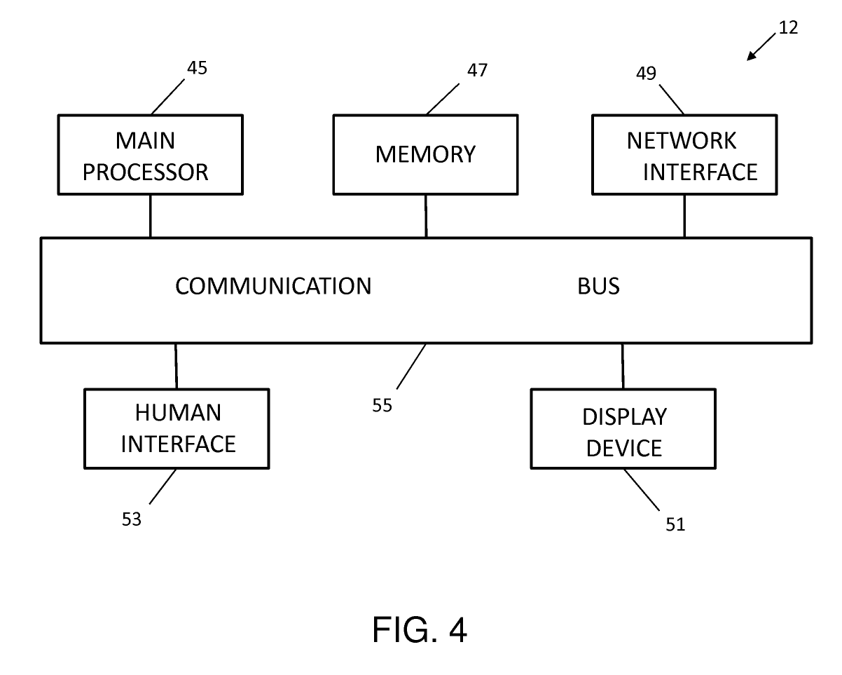

As best illustrated in FIG. 2, the system 10 includes a control architecture comprising a controller 50 in the form of a computing device. As illustrated in FIG. 4, the controller/computing device 50 includes one or more processors 45 and one or more memories 47. The controller/computing device 50 also includes one or more network interfaces 49 and one or more input/output devices such as display devices 51 and human interface 53. As should be appreciated, all of these components communicate with each other over a communications bus 55.

It should be appreciated that substantially any computing device 50 having a processor 45 can be utilized. Thus, the computing device 50 may take the form of a server, laptop, digital assistant, tablet computer, personal computer, or other computing device able to execute computer readable instructions.

The processor 45 may be referred to as a main processor or central processing unit (CPU). The processor 45 may include a single or multiple processing cores. Where two or more cores are provided, the cores may be capable of operating in parallel.

The memory 47 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 45 accesses the memory 47 through the communications bus 55 to access any application or data stored thereon including, but not limited to, any computer readable instructions.

The network interface 49 may be used to interface with any network 14 including a local area network (LAN), a wide area network (WAN), a wireless network or any other network or network of networks including that generally known as the internet. The input/output devices 51, 53 may comprise one or more computer monitors, printers or other display devices as well as human interfaces including but not limited to keyboards, mice, pointers, microphones, speakers or the like.

In the embodiment illustrated in FIG. 2, the controller 50 is connected to an integrated DC/DC converter/power source 52 through a control line 54. As illustrated the converter 52 includes an integrated power source 56 capable of providing up to 10 V and typically used at voltages below 2 V and ideally between 1.2-1.5 V. A first relay 58 and a second relay 62 are provided to reverse the polarity of the charging electrodes 18, 22 in cells 12, 14 in a manner described in greater detail below.

As further illustrated in FIG. 2, the controller 50 is connected via the control line 66 to a first conductivity sensor 68 and through a control line 70 to a first pH sensor 72. The conductivity sensor 68 and pH sensor 72 monitor the conductivity and pH of the desalinated water that is discharged from the first deionization cell 12 as the electrode pairs 18 in that cell are charged. As will be described below, by monitoring the conductivity of the desalinated water being discharged from a cell 12, 14, it is possible to determine when the charging and discharging of the cells should be reversed. The pH of the discharged desalinated water is monitored in order to determine any disruptions or equipment/carbon failure in the desalination system.

Similarly, the controller 50 is connected via the control line 74 to a second conductivity sensor 76 and through the control line 78 to a second pH sensor 80. The conductivity sensor 76 and the pH sensor 80 monitor the conductivity and pH of the desalinated water that is discharged from the second deionization cell 14 when the second set of electrode pairs 22 are being charged.

The controller 50 is also connected via the control line 82 to a pump 84 and the control lines 86, 88 and 90 to the flow control valves 92, 94, 96. As illustrated in FIG. 1, the pump 84 pumps salt water from the salt water source 98 to the control valve 92. Flow control valve 82 directs that salt water selectively to the first deionization cell 12 or the second deionization cell 14. The flow control valve 94 selectively directs the discharge flow from the first deionization cell 12 to either the wastewater reservoir 100 or the desalinated water reservoir 102. Similarly, the control valve 96 directs the flow discharge from the second deionization cell 14 to either the wastewater reservoir 100 or the desalinated water reservoir 102.

As should be appreciated, the capacitive deionization system 10 is particularly suited for use in a method of desalinating water. The method may be broadly described as comprising the steps of: (a) pumping salt water, by means of the pump 84 and the control valve 92, into the first deionization cell 12 at a predetermined processing rate of, for example, between 5 and 1,000,000 ml/min, (b) applying, by operation of the converter 52, a processing voltage (typically of between 0.4 and 2.0 V) across the first set of electrode pairs 18 to deionize the salt water and produce desalinated water, (c) directing, by means of the flow control valve 94, the desalinated water from the first deionization cell 12 to a desalinated water reservoir 102 and (d) applying, by operation of the converter 52, the processing voltage for the first set of electrode pairs 18 by discharging the second deionization cell 14 and adding “topping power” from the integrated power source 56. For example, if it is desired to supply 14 J of energy to the electrode pairs 18 in cell 12 and the discharging of the second cell 14 only provides 8 J, topping power resulting in 6 J (14 J−8 J=6 J) is provided by through the converter 52 from the integrated power source 56.

The method further includes (e) monitoring, by the conductivity sensor 68, the conductivity of the desalinated water discharged from the first deionization cell 12 and stopping, by operation of the converter 52, application of processing voltage to the first set of electrode pairs 18 upon the conductivity reaching a predetermined level. In addition the method includes the step of (f) directing, by flow control valve 96, a wastewater stream from the second deionization cell 14 to the wastewater reservoir 100 once the second cell has been fully discharged.

Still further, the method includes: (g) pumping, by means of the pump 84 and the control valve 92, salt water from the salt water source 98 to the second deionization cell 14 at a predetermined processing rate (typically between 5 and 1,000,000 ml/min). This is followed by the step of (h) applying, by operation of the converter 52, a processing voltage (typically of between 0.4 and 2.0 V) across the second set of electrode pairs 22 to deionize the salt water and produce desalinated water in the second cell 14. Next is the (i) directing, by flow control valve 96, of the desalinated water from the second deionization cell 14 to the desalinated water reservoir 102. This is followed by the step of (j) providing, by operation of the converter 52, the processing voltage for the second set of electrode pairs 22 by discharging the first deionization cell 12 and adding “topping power” from the integrated power source 56.

In addition the method includes the step of (k) monitoring, by the conductivity sensor 76 the conductivity of the desalinated water exiting the second deionization cell 12 and stopping, by operation of the converter 52, the application of the processing voltage to the second set of electrode pairs 22 upon the conductivity reaching a predetermined level. Further the method includes the step of (l) directing, by flow control valve 94, a wastewater stream from the first deionization cell 12 to the wastewater reservoir 100 when the first deionization cell has been fully discharged. Finally, the method includes the steps of repeating steps (a)-(l) indefinitely so as to allow for the continuous processing of salt water into desalinated water.

Reference is now made to the following example which further illustrates the system 10, and associated method for capacitive deionization used in the desalination of salt water into potable water.

In this capacitive deionization (CDI) operation, a salt solution was flowed through the carbon xerogel (CX) electrodes 18 and an applied potential was used to adsorb ionic content from the incoming salt stream onto the CX electrodes. The salt solution can range anywhere from <1 ppm to >35 ppt, but typical salt concentrations have been from 200 ppm to 5 ppt. Ideally, the salt solution would be below 1 ppt for extremely efficient capture. The applied potentials can range anywhere from 0-3 V, but typical operation has been carried out between 0.4-2 V. Ideally, the applied potential is from 1-1.5 V. A period of 5 min-2 hours has been used to adsorb ionic content onto the carbon xerogel electrode surfaces depending on the flow rate used and the incoming salt concentration. The flow rates have ranged from less than 10 ml/min to greater than 100 ml/min depending on the size of the CDI cell being used. Using the integrated DC/DC converter/power source 52, an initial CDI cell 12 has been charged at a voltage ranging from 0-2 V. A conductivity sensor 68 monitored the product stream leaving this initial CDI cell 12. When conductivity began to increase, the CDI cell 12 started to become saturated in salt content. When saturated, the CDI cell 12 was effectively a charged supercapacitor. The converter 52, controlled by a computer/microcontroller 50, stopped charging the initial CDI cell 12. Solution flow was diverted to a secondary CDI cell 14 using a controlled valve 92, and the secondary CDI cell 14 was charged using the energy stored in the initial CDI cell 12 along with “topping power” supplied by the integrated power source 56 by converter 52. The initial CDI cell 12 discharged its ionic content into a concentrated salt waste stream while the secondary cell 14 continued deionizing a salt stream. When the secondary cell 14 became saturated in salt content (as registered again by an increase in the conductivity reading, this time from sensor 76), the converter stopped charging the secondary CDI cell 14 and began charging the initial CDI cell 12 using the stored energy in the secondary cell as well as “topping power” provided again by the integrated power source 56. Operation continued in this manner of charging (desalinating a stream) and discharging (concentrated waste stream and energy release) to provide a constant stream of deionized water as well as the collection of a concentrated wastewater stream. A DC/DC converter 52 composed of a unique bidirectional tuk-derived circuit with integrated power source 56 handled energy transfer between 2 or more CDI cells or banks of cells.

In previously known CDI systems, performance loss will take place over time in the CDI cells 12, 14. To maintain system performance, the relays 58, 62 are incorporated with the integrated DC/DC converter/power source which will periodically alternate the positive and negative electrode in the CDI cell/bank of cells 12, 14. The integration of these relays into the desalination system is shown in FIG. 2.

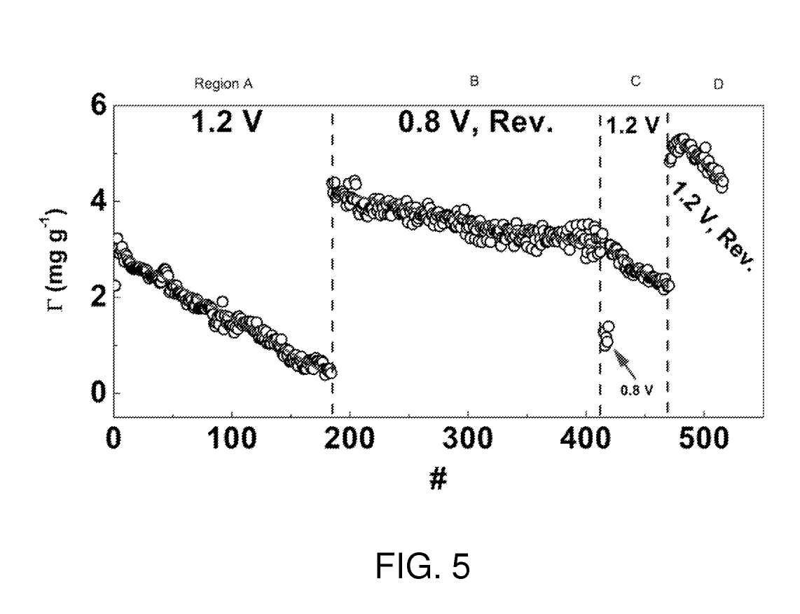

Shown in FIG. 5 is the salt capacity the carbon electrode (monolithic carbon xerogel in this case) as a function of cycle number. Each cycle was composed of a charging and discharging cycle. Potential increases as well as electrode potential reversal (relay switching) maintained and even increased the salt removal capacity of the CDI cell or bank of CDI cells.

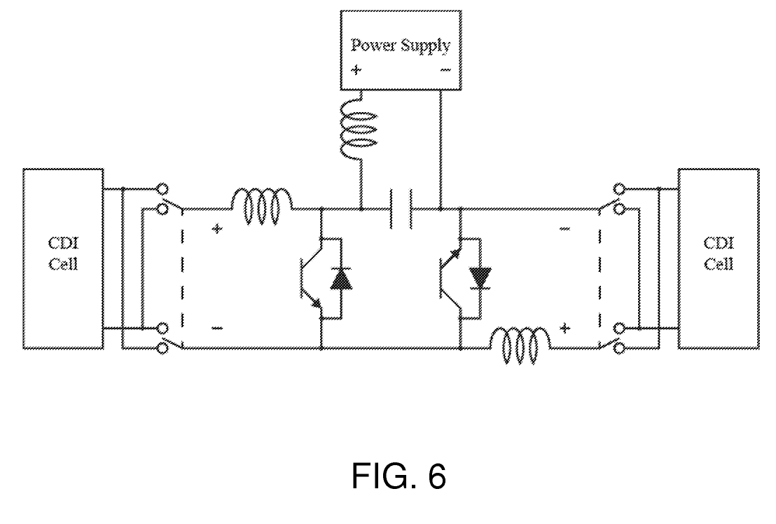

In detail, the integrated DC/DC converter/power source 52 used in this example was a bidirectional DC/DC converter with a Ćuk-derived topology as illustrated in FIG. 6. It consisted of two switching devices. These devices may be MOSFETs, BJTs, or other switching devices. These devices may be combinations (e.g., parallel or series) of these devices. These devices may include an antiparallel diode. Synchronous rectification may be used to control these switches. A filter may be used at each of the two primary terminals of the converter, connected to the first and second cell 12, 14. This filter may be used to reduce the current ripple of the currents flowing in and out of each cell. This filter may consist of an inductor. A power source is used as the transfer source in the tuk-topology to provide the difference between the energy required by a charging cell and the energy provided by a discharging cell. The source may be interfaced with a filter. The filter may be used to reduce the current ripple of the current flowing from the voltage source. The filter may consist of an inductor and a capacitor. The converter is switched such that one switch is closed and the other is opened. Subsequently, the first switch is opened and the second switch is closed. The switches may be switched at a frequency between 100 Hz and 1 MHz, or between 1 kHz and 100 kHz.

The operation of this process using two or more CDI cells or bank of cells 12, 14 with the integrated DC/DC converter/power source 52 and relays 58, 62 is summarized as follows:

An initial CDI cell or bank of cells 12 desalinates a salt stream between 0-2 V until the electrodes become saturated in salt content. A slight increase in the conductivity will signal the beginning of saturation of the cell.

At this point, the stream will be redirected to a secondary cell 14 for the removal of salt content. This stream will be deionized using the energy stored in the initial cell 12 with added energy (“topping power”) from a power source 56 which is integrated with the converter 52 handling the energy transfer.

Once the secondary cell 14 becomes saturated, the stream will be redirected again to the initial cell 12 which has been discharged during the charging process of the secondary cell. It will be powered using the energy stored in the secondary cell 14 as well as additional energy from the integrated power source 56.

This process of charging and discharging of initial and secondary CDI cells or bank of cells 12, 14 will be repeated with this integrated DC/DC converter/power source (unique component of the system) 52 between 0-2 V until performance degradation is seen. This degradation will be evidenced by measuring the conductivity of the outlet stream with a sensor or probe 68, 76 connected to the controller 50 of our system 10. At this point, the potential will be increased to higher than the initial starting value for charging and salt removal. When further degradation is seen, the potential will be further increased. Potential will continue to be increased up to 2 V to maintain the salt removal performance of the device.

When performance loss is seen at 2 V, the electrical connections will be switched using integrated relays 58, 62 (controller 50 will handle this). This unique operational parameter of the system will maintain/enhance the performance. The significance/importance of this aspect is the prolonged operation of a desalination device producing a consistently deionized stream for the customer. Again, charging will take place at 0-2 V as performance losses are seen. When performance loss is again seen at 2 V, the electrical connections will again be switched with the integrated relays 58, 62 (controller 50 will handle this).

The process of increasing the potential to maintain performance followed by alternating the electrical connections to the anode and cathode will insure a deionized stream to the customer. Alternatively, the electrical connections can be switched between each desalination cycle using the integrated relays 58, 62 to maintain consistent desalination performance.

The integrated DC/DC converter/power source 52 will handle the transfer of energy between these cells/banks of cells 12, 14 as well as the varied voltage (with a controller system and conductivity sensor) used to maintain performance output of the device.

The foregoing has been presented for purposes of illustration and description. It is not intended to be exhaustive or to limit the embodiments to the precise form disclosed. Obvious modifications and variations are possible in light of the above teachings. For example, the controller 50 may be implemented using electronics without the use of a computing device if desired. Further, the controller 50 and converter 52 may function in one possible embodiment to provide both constant voltage and constant current operation for desalination. All such modifications and variations are within the scope of the appended claims when interpreted in accordance with the breadth to which they are fairly, legally and equitably entitled.

What is claimed:

1. A capacitive deionization system, comprising:
a first deionization cell including a first reservoir and a first set of electrode pairs;
a second deionization cell including a second reservoir and a second set of electrode pairs; and
a DC/DC converter connected to said first and second sets of electrode pairs.

2. The system of claim 1, wherein said first and second deionization cells are provided in parallel whereby said first deionization cell is being charged while said second deionization cell is being discharged.

3. The system of claim 2, wherein said converter includes an integrated power source.

4. The system of claim 3, further including a conductivity sensor for monitoring conductivity of desalinated water being discharged from either of said first deionization cell or said second deionization cell.

5. The system of claim 4, further including a pH sensor for monitoring pH of desalinated water being discharged from either said first deionization cell or said second deionization cell.

6. The system of claim 5, further including a pump for pumping salt water through one of said first and second deionization cells.

7. The system of claim 6, further including a controller connected to said DC/DC converter, said conductivity sensor, said pH sensor and said pump.

8. The system of claim 7, further including a first flow control valve between said pump and said first and second deionization cells for selectively directing salt water from said pump to said first and second deionization cells.

9. The system of claim 8, further including a wastewater reservoir and a desalinated water reservoir.

10. The system of claim 9, further including a second flow control valve downstream from a first outlet from said first deionization cell for selectively directing flow to said wastewater and desalinated water reservoirs and a third flow control valve downstream from a second outlet from said second deionization cell for selectively directing flow to said wastewater and desalinated water reservoirs.

11. The system of claim 1, wherein said electrode pairs are xerogel electrodes with a silica film coating.

12. In a capacitive deionization system including a first deionization cell having a first set of electrode pairs, a second deionization cell having a second set of electrode pairs, a DC/DC converter with an integrated power source and a controller, a method comprising;
(a) pumping salt water, by a pump, into said first deionization cell at a predetermined processing rate;
(b) applying, by operation of said converter, a processing voltage across said first set of electrode pairs to deionize said salt water and produce desalinated water;
(c) directing, by flow control valve, said desalinated water from said first deionization cell to a desalinated water reservoir; and
(d) providing, by operation of said converter, said processing voltage for said first set of electrode pairs by discharging said second deionization cell and adding topping power from integrated power source.

13. The method of claim 12, further including (e) monitoring, by conductivity sensor, conductivity of said desalinated water discharged from said first deionization cell and stopping, by operation of said converter, application of processing voltage to said first set of electrode pairs upon said conductivity reaching a predetermined level.

14. The method of claim 13, including (f) directing, by flow control valve, a wastewater stream from said second deionization cell to a wastewater reservoir.

15. The method of claim 14, including:
(g) pumping, by a pump, salt water into said second deionization cell at a predetermined processing rate;
(h) applying, by operation of said converter, a processing voltage across said second set of electrode pairs to deionize said salt water and produce desalinated water;
(i) directing, by flow control valve, said desalinated water from said second deionization cell to said desalinated water reservoir; and
(j) providing, by operation of said converter, said processing voltage for said second set of electrode pairs by discharging said first deionization cell and adding topping power from said integrated power source.

16. The method of claim 15, further including (k) monitoring, by conductivity sensor, conductivity of said desalinated water exiting said second deionization cell and stopping, by operation of said converter, application of processing voltage to said second set of electrode pairs upon said conductivity reaching a predetermined level.

17. The method of claim 16, including (l) directing, by flow control valve, a wastewater stream from said first deionization cell to said wastewater reservoir.

18. The method of claim 17, including repeating steps (a)-(l).
